(19) United States
(12) Patent Application Publication
(10) Pub. No.: US 2023/0067086 A1
(43) Pub. Date: Mar. 2, 2023

(54) TRANSFORMATION OF CLOUD-BASED DATA SCIENCE PODS

(71) Applicant: Keylogic Technologies Corp., Morgantown, WV (US)

(72) Inventors: Alexander F. Karman, Annandale, VA (US); Christopher M. Waychoff, Bethesda, MD (US); Harry McKinney, Harriman, TN (US); Abdul Rahman, Accokeek, MD (US); Peter Kessler, Reston, VA (US)

(21) Appl. No.: 17/897,561

(22) Filed: Aug. 29, 2022

Related U.S. Application Data
(60) Provisional application No. 63/238,948, filed on Aug. 31, 2021.

(51) Int. Cl. G06F 9/50; G06N 5/02

(52) U.S. Cl. CPC G06F 9/5072; G06F 9/5077; G06N 5/022

(57) ABSTRACT

The disclosed invention provides a system on a cloud-hosted containers or containerized environment for performing complex modeling and analytics on big data that allows the analytics performed in it are reproducible at any time despite changes to the cloud ecosystem. The cloud-hosted, future-proofed containers allows previously completed analytics, data, research, publications, websites, etc., to be future proofed by detecting pending or proposed changes to the cloud ecosystem and updating projects automatically to be reproducible in the future ecosystem.

### CROSS-REFERENCE TO RELATED APPLICATIONS

The present patent application claims the priority benefit of U.S. provisional patent application 63/238,948 filed Aug. 31, 2021, the disclosure of which is incorporated by reference herein

### BACKGROUND OF THE INVENTION

### 1. Field of the Disclosure

The present disclosure is generally related to maintaining and updating cloud-hosted platforms through evolutionary changes. More specifically, the present disclosure is concerned with transformation of data science pods associated with cloud-based projects.

### 2. Description of the Related Art

Modern digital software applications are increasingly built and developed in the form of “containers,” which are microservices packaged with their associated dependencies and configurations. As used herein, containers generally refer to packages of software that contain all of the necessary elements to run in any computing environment. Thus, containers may virtualize the operating system and run anywhere—from a private data center to the public cloud or even on a developer's personal laptop. The container may therefore function in any containerized environment from a cloud to a laptop.

For example, Kubernetes is an open-source software platform for deploying and managing these software containers at scale. Containers may have dependencies on other containers as well as dependencies on underlying infrastructure services and resources in the cloud ecosystem. Current platforms (e.g., Kubernetes) possess the ability to define and orchestrate interactions among containers, as well as to monitor the health of containers and scale them up or down or restart them as required.

In order to adapt or update these containers, an analyst or administrator must maintain and otherwise keep the containers up-to-date or else risk having to abandon the original containers altogether upon becoming out-of-date. Maintaining the software containers may be complicated, however, as there must be a series software patches or modifications in historical order in order to match the evolution of the system. While some platforms may have version control features that allow for deployment of the correct versions of related containers together, such version control capabilities of existing platforms are geared to the expectation that application code changes may occur at a far more rapid pace than ecosystem changes.

That is not the case, however, with containers used for supporting artificial intelligence (AI), machine learning (ML), and data science (DS). On such platforms, substantial changes to the underlying cloud ecosystem generally require substantial changes to container definitions, as well as re-installation of platform components themselves. Therefore, the meaningful life span of a sophisticated analytical project usually does not surpass several months. As a result, current cloud-hosted analytic platforms supporting artificial intelligence (AI), machine learning (ML), and data science (DS) workflows and pipelines that use containers are difficult to reproduce and repurpose if there are changes within the cloud environment.

Cloud architectures may generally have three main characteristics: elasticity, self-service, and co-tenancy. Elasticity may refer to the ability of account-holders or other users to easily create or delete resources in the cloud. Self-service may refer to the ability of account-holders or other users to create, observe, configure, integrate, manage, and delete their own resources that are stored in the cloud (e.g., one or more cloud servers). Co-tenancy may refer to the ability of multiple account-holders or other users to have resources deployed to the same physical machines without being able to see or interact with each other's co-located resources.

Co-tenancy is the characteristic that tends to make it impossible to resurrect an old data science project. The security frameworks and paradigms that support co-tenancy evolve rapidly in ways that data scientists cannot anticipate. The longer a project has been dormant, the less likely it is that the account holder or cloud administrators can determine how to modify the project in order to make the project deployable within a new architecture. The solution usually requires a large number of order-dependent procedural tasks that are unique to each resurrected project.

There is therefore a need in the art for improved systems and methods of updating cloud-hosted containers in a simple, quick, and efficient manner that supports AI, ML, and DS development and deployment efforts. Such improved systems and methods may include automated transformation of containers that interact in an analytical project (i.e., AI, ML, and DS), so that the analytical functionality of the containers is preserved in a substantially changed cloud ecosystem while preserving necessary aspects of the dependency tree.

### SUMMARY OF THE CLAIMED INVENTION

As used herein, a data science pod may refer to a containerized environment with compute resources, memory, and access to referenced data sources where users may perform exploratory data analysis and generate reports and predictive models as tangible outputs. Embodiments of the present invention may future-proof data science pods by subdividing a data science pod into three distinct components: the data pod, the compute pod and the publication pod. The subdivision facilitates behavioral definitions. Further, mapping functions may be provided to transform each subcomponent from obsolete container grammars into the current container grammar.

Embodiments of the present invention include leveraging of the fact that container technologies rely upon declarative grammars to define resources, interfaces, behaviors, and roles. Mapping functions may be used to transform obsolete definitions into current definitions without the need to define or execute order-dependent tasks. This is possible because the cloud's current container management system becomes able to understand the sequence of order-dependent procedural tasks that need to be executed in order to fulfill the container definitions once the definitions have been transformed into the current container management grammar. Even if cloud owners introduce out-of-band manual steps (such as requirements for explicit email communications and permission to operate), the mapping functions allow for the steps to be exactly identical for the resurrected data science project as for all other projects. The introduced steps will not be unique to the resurrected project, and the solution will therefore be known. The transformation may function in any containerized environment, including a containerized environment installed on bare metal, a single cloud environment, a hybrid cloud/bare metal environment, or a federated multi-cloud environment.

Embodiments of the present invention include transforming cloud-based data science pods. Information regarding a project associated with a plurality of different pods may be stored in memory or otherwise serialized and persisted to physical storage. The stored information may include a map of a plurality of relationships among containers of project components associated with each of the pods. At least one of the pods may be queried regarding a current configuration status relative to a requested ecosystem configuration. The current configuration status of the at least one pod may be identified as not being acceptable in accordance with the requested ecosystem configuration. A mapping function may be executed to update the respective configuration status of the at least one pod based on the mapped relationships stored in memory. The executed mapping function may generate instructions for one or more configuration changes that implement the update to the requested ecosystem configuration.

The mapping functions may be stored in memory and can persist serialized representations thereof to physical storage. The mapping functions may be browsable and selectable both from memory and from physical storage. The mapping functions may be generated in several ways. For example, the mapping functions may be trained by fitting predictive models from surveilled container management communications or logs. The mapping functions may also be added to the knowledge graph manually. In some implementations, mapping functions may be inferred from the knowledge graph using Horn logic reasoning. Mapping functions may also be discovered by browsing external (third party) knowledge graph repositories. The knowledge graph may contain both direct substitutions, as well as abstract syntax tree subsets. Direct substitutions may provide known equivalents between obsolete grammars and the current grammar. Abstract syntax trees may compute heretofore-unknown equivalents between obsolete grammars and the current grammar.

### BRIEF DESCRIPTIONS OF THE DRAWINGS

FIG. 1 illustrates an exemplary network environment in which a system for cloud-based transformation of data science containers may be implemented.

FIG. 2 is a flowchart illustrating an exemplary method for cloud-based transformation of data science containers.

FIG. 3A-C illustrate exemplary mapping function transformations that may be executed upon data science containers.

FIG. 4 is a block diagram of an exemplary computing device that may be used to implement an embodiment of the present invention.

### DETAILED DESCRIPTION

Embodiments of the present invention include transforming cloud-based data science pods. Information may be stored in memory regarding a project associated with a plurality of different pods. The stored information may include a map of a plurality of relationships among containers of project components associated with each of the pods. At least one of the pods may be queried regarding a current configuration status relative to a requested ecosystem configuration. The current configuration status of the at least one pod may be identified as not being acceptable in accordance with the requested ecosystem configuration. A mapping function may be executed to update the respective configuration status of the at least one pod based on the mapped relationships stored in memory. The executed mapping function may generate instructions for one or more configuration changes that implement the update to the requested ecosystem configuration.

Embodiments of the present invention include systems and methods for cloud-based transformation of a data science containers. Systems and methods consistent with the present disclosure make it possible for the first time to automate the transformation of containers that interact in a data analytics project (e.g., AI, ML, and DS). Thus, the analytical functionality of the containers is preserved in a substantially changed cloud ecosystem, all the while preserving necessary aspects of the dependency tree. Moreover, such automated transformation may be accomplished in a single step, rather than by maintaining and recreating the history of all ecosystem changes that had occurred during an intervening time as is required by existing technology. The automated transformation may be accomplished based on creating and executing mapping functions that recognize associations between prior ecosystem states and current ecosystem states, as well as based on identifying container management artifacts that require modification and automatically transforming the associated syntax.

The system may employ a concept graph (for knowledge representation), which maintains a project-orientation, which codifies the relationships between the actor and role entities in a project and the expected behavior of the components to perform the expected analytical goals of the project. For every AI, ML, or DS related project, the system creates three pods of logically related containers: (1) a data pod, in which connections to data resources in the cloud are established and simple calculations and manipulations are performed; (2) a compute pod, where complex calculations are performed; and (3) a publication pod in which desired outputs are generated and delivered to appropriate cloud resources. The division of each project into three categories of pods makes the generation of mapping functions substantially less complex and more robust.

In accordance with embodiments of the present invention, currently operating analytical projects may continue operating after substantial cloud ecosystem changes, and analytical projects that have been inactive for a very long time may be reproduced much later (even years later). Such reproduction may occur even though many substantial ecosystem changes have occurred during the intervening time, and no record of the changes may have been preserved.

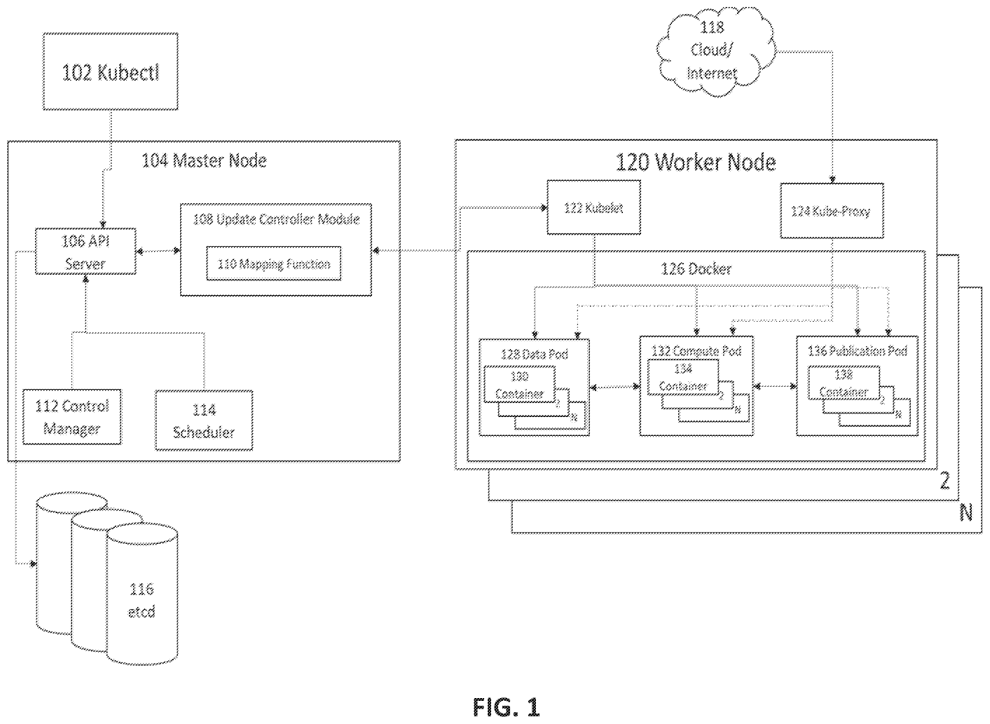

FIG. 1 illustrates an exemplary network environment in which a system for cloud-based transformation of data science containers may be implemented. As illustrated, the network environment—which may correspond to a Kubernetes platform—may include a kubectl 102, master node 104, API server 106, update controller module 108, mapping function 110, control manager 112, scheduler 114, etcd 116, cloud or Internet 118, worker node 120, kubelet 122, kube-proxy 124, Docker 126, data pod 128, container 130, compute pod 132, container 134, publication pod 136, container 138.

The illustrated network environment provides for an automatically future-proofed and cloud-hosted analytics system that allows the analytics to be performed in a manner reproducible at any time in the future, despite changes to the cloud ecosystem. The system can leverage any vendor's analytics platform, generate a custom-defined analytics platform, run in any vendor's cloud, across multiple clouds, or on-premises.

Cloud ecosystems evolve and mature over time, experiencing many changes, especially to their security models, control planes, data models, and to the methods provided to physically access the data. The system future-proofs analytics projects by detecting pending or proposed changes to the ecosystem and updating projects automatically so that they may still be reproducible in the future ecosystem. The system utilizes the workflow within a project that consists of three fundamental stages: accessing data and performing some cleansing and/or manipulation to the data, described as a data pod 128 in the system; performing intensive modeling to the data, described as a compute pod 132 in the system; and taking the output of some insight or product and making such output available to others, described as a publication pod 136 in the system.

This workflow data for a project is formalized in a knowledge graph, which understands the concepts of inputs, dependencies, and outputs for a project to ensure that they work within a new environment. The knowledge graph is tailored to a particular project orientation or requirement into dissectible and decomposable components that map specifically to the data required, processing needed, and the outputs demanded. The knowledge graph contains associations between expected behavior and the syntax necessary to implement the project into the new ecosystem or environment, such as the impacted syntax, mapping function 110, and ecosystem change types that informs the system what syntax to scan for and what mapping function 110 to apply for every ecosystem modification.

The system utilizes semantic queries and inference in which the system uses a query language to query the knowledge graph. The system then utilizes the data stored in the knowledge graph to build a model that may allow the system to make a prediction or forecast whether the current configuration may fail in the new ecosystem or environment and updates the configuration if needed through the update controller module 108. The update controller module 108 determines whether the components are still compatible with one another and if the underlying cloud environment is to behave as expected. The system's ability to determine if the components are still compatible comes from an industry-wide practice of defining and deploying pods and their containers using deployment artifacts written in declarative programming languages.

Existing cloud platforms may use deployment descriptors and configuration items written in declarative programming language, declarative grammars, or declarative documents to define, deploy, and manage cloud-hosted resources, such as containers, and are easy to transform with a mapping function 110. The mapping function 110 may be one-step mathematical functions for the simplest of changes, multi-step algorithms for more complex changes, or abstract syntax trees for the most complex of changes. The system can query project artifacts to identify instructions or configurations that should be changed to accommodate the new ecosystem or environment and then use the mapping function 110 to generate the required changes. This allows the system to future-proof analytics projects to allow the projects to be reproducible from a prior ecosystem state to a current ecosystem state or from a current ecosystem state to a future ecosystem state. The examples provided depict this system in a Kubernetes platform. The system is functional, however, in any type of analytics platform, data science platform, data science engine, AI (artificial intelligence) platform, etc. The examples set forth herein are therefore non-limiting examples and are merely examples among other possible examples.

A kubectl 102 may be a command line tool to allow a user to control Kubernetes clusters and may allow a user to perform any Kubernetes operation. In some embodiments, a kubectl 102 may be used to deploy applications, inspect, and manage cluster resources, and view logs. In some embodiments, the future-proofing, cloud-hosted analytics system may be located on an analytics system, such as a data science platform, data science engine, or Artificial Intelligence (AI) platform. In some embodiments, the system may be located on any cloud-hosted containerized environment for performing complex modeling and analytics on big data, with a user-friendly, vendor-managed system for deployment, code development, and running big data operations, and deletion.

A master node 104 may be the main controlling unit of the cluster. The master node 104 may manage workload and direct communications across the system. The master node 104 may contain an API server 106, an update controller module 108, a mapping function 110, a control manager 112, and a scheduler 114. In some embodiments, there may be a single master node 104, or there may be a plurality of master nodes 104. Placement of components on master and server nodes is not critical and may vary between platforms. An API server 106 or Kubernetes API may provide both the internal and external interface to the Kubernetes system.

The API server 106 processes and validates requests, as well as updates the state of the API objects in the etcd 116, which allows clients to configure workloads and containers across the worker nodes 120. An update controller module 108, which is initiated by the scheduler 114, in some embodiments the update controller module 108 may be initiated by the control manager 112, a user through the kubectl 102, or through the API server 106.

The update controller module 108 executes a read of the data pod 128, compute pod 132, and the publication pod 136. The update controller module 108 sends a query to the data pod 128, compute 132, and the publication pod 136 for the configuration that the respective pod may be using. The update controller module 108 then determines if the data pod 128, compute pod 132, and the publication pod 136 is using an acceptable configuration. An acceptable configuration may be a current configuration of an ecosystem. If using a prior configuration of the ecosystem, the configuration may need to be updated to the current configuration of the ecosystem. An acceptable configuration may also be a future configuration of an ecosystem. If using a current configuration in such instances, the configuration may need to be updated to the future configuration of the ecosystem.

For example, the system maintains a knowledge graph of impacted syntax, mapping functions 110, and ecosystem change types that informs the system what syntax to scan for and what mapping function 110 to apply for every ecosystem modification. If it is determined that the data pod 128, compute pod 132, or the publication pod 136 is not using an acceptable configuration the mapping function 110 is executed to update the configuration. For example, the system maintains a knowledge graph of impacted syntax, mapping functions 110, and ecosystem change types that informs the system what syntax to scan for and what mapping function 110 to apply for every ecosystem modification.

Existing cloud platforms use deployment descriptors and configuration items written in declarative programming language, declarative grammars, or declarative documents to define, deploy, and manage cloud-hosted resources, such as containers, and are easy to transform with a mapping function 110. The mapping function 110 may be one-step mathematical functions for the simplest of changes, multi-step algorithms for more complex changes, or abstract syntax trees for the most complex of changes. Then the update controller module 108 updates the declarative programming language. For example, the mapping function 110 may accept as input a declarative document in one declarative programming language and format and generate as output another document in the required declarative programming language and format.

A mapping function 110 may query project artifacts to identify instructions that should change to accommodate an ecosystem change, and then generate the required changes. Thus, the viability of all projects is preserved throughout successive ecosystem changes, thereby providing the ability to future-proof analytics projects so that they can be reproduced and extended even after years of disuse with no intermediate patching. It is therefore not necessary to apply a series of patches and modifications in historical sequence nor to match the historical evolution of the ecosystem.

A control manager 112 may be a controller that is a reconciliation loop that drives the actual cluster state toward the desired cluster state. Control manager 112 may communicate with the API server 106 to create, update, and delete managed resources, such as pods, service endpoints, etc. The control manager 112 may be a process that manages a set of Kubernetes controllers. For example, there may be various different controllers, such as a replication controller that handles replication and scaling by running a specified number of copies of a pod across the cluster (as well as handling creation of replacement pods if the underlying node fails), a job controller for running pods to completion (such as part of a batch job), or a DaemonSet controller for running one pod on every machine or some subset of machines.

A scheduler 114 may be a component that selects which node for an unscheduled pod to run on based on resource availability. The scheduler 114 tracks resource use on each node to ensure that workload is not scheduled in excess of available resources. The scheduler 114 should know the resource requirements, resource availability, and other user-provided constraints and policy directives, such as quality of service, affinity requirements, data locality, and so on.

A distributed, reliable key-value store, such as etcd 116, may be a persistent, lightweight, distributed, key-value data store that reliably stores the configuration data of the cluster. The etcd 116 may represent the overall state of the cluster at any given point of time. The etcd 116 may be a system that favors consistency over availability in the event of a network partition, which is crucial for correctly scheduling and operation services. The API server 106 uses a watch API of etcd 116 to monitor a cluster and roll out critical configuration changes or simply restore any divergences of the state of the cluster back to what was declared by the deployer. For example, if the deployer specified that three instances of a particular pod need to be running, such specification may be stored in the etcd 116. If it is found that only two instances are running, this delta may be detected by comparison with the etcd 116 data and Kubernetes may use such delta to schedule the creation of an additional instance of that pod.

A cloud 118 or communication network may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques known in the art. The communication network may allow ubiquitous access to shared pools of configurable system resources and higher level services that can be rapidly provisioned with minimal management effort, often over the Internet. The communication network may rely on sharing of resources to achieve coherence and economies of scale (e.g., like a public utility), while third-party clouds enable organizations to focus on their core businesses instead of expending resources on computer infrastructure and maintenance.

A worker node 120 may be a machine where containers (or workloads) are deployed, and every node in the cluster may run a container runtime such as Docker 126, a kubelet 122, a kube-proxy 124, a data pod 128, a compute pod 132, a publication pod, and containers 130/134/138. A worker node 120 communicates with the master node 104 for network configuration of these containers 130/134/138.

A kubelet 122 may be responsible for the running state of each node and ensuring that all containers on the node are healthy. The kubelet 122 may handle starting, stopping, and maintaining application containers organized into pods as directed by the master node 104. The kubelet 122 may also monitor the state of a pod, and if not in the desired state, the pod may be re-deployed to the same node. The status of worker nodes 120 is relayed to the master node 104. Once the master node 104 detects a worker node 120 failure, the control manager 112 observes the state change and launches pods on other healthy worker nodes 120.

A kube-proxy 124 may be an implementation of a network proxy and a load balancer. The kube-proxy 125 may support the service abstraction along with other networking operations. The kube-proxy 124 is responsible for routing traffic to the appropriate container based on IP and port number of the incoming request.

A container provider, such as Docker 126, may be a set of platform-as-a-service products that use OS (operating system)-level virtualization to deliver software in packages called containers, such as containers 130/134/138. Containers 130/134/138 may be isolated from one another and may bundle their own software, libraries, and configuration files. Containers 130/134/138 may also communicate with each other through well-defined channels.

A data pod 128 may be comprised of one or more containers that each access raw data and manipulate the raw data into commonly used data structures, such as Data Frames. Such data structures may be distributed because of their size (e.g., SparkDataFrames). In some embodiments, a pod may be a group of containerized components. The one or more containers in each pod may be guaranteed to be co-located on the same worker node 120. In some embodiments, each pod may be assigned a unique IP address within the cluster, which allows applications to use ports without the risk of conflict. In some embodiments, all containers within a pod can reference each other on localhost, but a container within one pod cannot directly address another container within another pod.

The pod may use the pod IP address. In some embodiments, a pod can define a volume (such as a local disk directory or a network disk) and expose the volume to the containers in the pod. Pods can be managed manually through the server API 106, or their management can be delegated to a controller. In some embodiments, such volumes may be the basis for Kubernetes ConfigMaps (that provide access to configuration through the filesystem visible to the container) and Secrets (that provide access to credentials needed to access remote resources securely) by providing those credentials on the filesystem visible only to authorized containers.

A container 130, which resides in a data pod 128, may be the lowest level of a micro service that holds running an application, libraries, and their dependencies and that can be exposed through an external IP address. Similarly, container 134, which resides in a compute pod 132, may be the lowest level of a micro service which holds running an application, libraries, and their dependencies, and can be exposed through an external IP address. Likewise, container 138, which resides in a publication pod 136, may be the lowest level of a micro service which holds running an application, libraries, and their dependencies, and can be exposed through an external IP address.

A compute pod 132 may be comprised of containers that model or analyze the data structures in the associated data pod 128. Meanwhile, a publication pod 136 may comprise of containers that publish or host analytical products developed in the compute pod 132 to a broader audience of users or machines (e.g., documents, websites, machine-to-machine services, and interfaces).

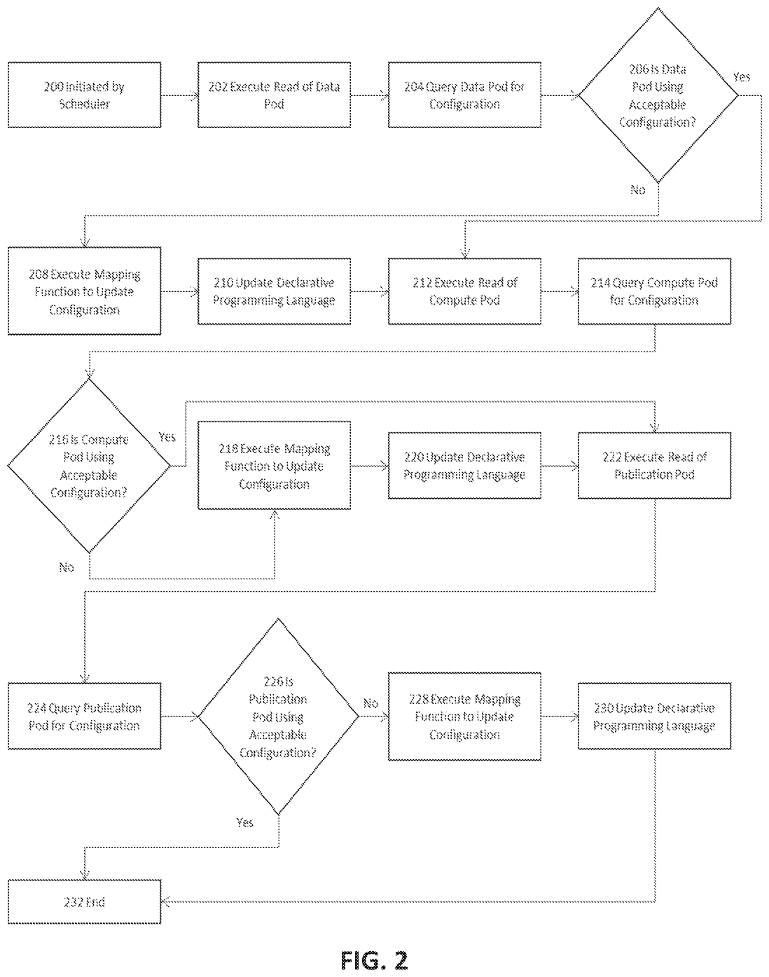

FIG. 2 is a flowchart illustrating an exemplary method for the update controller module. The illustrated method may be performed by the update controller module 108. The method of FIG. 2 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 2 (and the order thereof) are exemplary and may include various alternatives, equivalents, or derivations thereof including but not limited to the order of execution of the same.

The method begins with step 200, in which the update controller module 108 is initiated by the scheduler 114. In some embodiments, the update controller module 108 may be initiated by the control manager 112, a user through the kubectl 102, or through the API server 106.

In step 202, the update controller module 108 executes a read of the data pod 128. The data pod 128 may be comprised of containers that access raw data and manipulate the raw data into commonly used data structures.

In step 204, the update controller module 108 sends a query to the data pod 128 for the specific configuration that the data pod 128 is using. For example, the update controller module 108 sends a query for the declarative programming language that the data pod 128 is currently using.

In step 206, the update controller module 108 then determines if the data pod 128 is using an acceptable configuration. For example, the system may maintain in memory a knowledge graph representation of impacted syntax, mapping functions 110, and ecosystem change types that informs the system what syntax to scan for and what mapping function 110 to apply to it for every ecosystem modification.

If it is determined that the data pod 128 is not using an acceptable configuration or may not produce the expected behavior in the current ecosystem, the method may proceed to step 208 in which the mapping function 110 is executed to update the data pod 128 configuration. For example, the system maintains a knowledge graph of impacted syntax, mapping functions 110, and associated ecosystem change types. The knowledge graph therefore informs the system what syntax to scan for and what mapping function 110 to apply for every ecosystem modification. The mapping function 110 may be one-step mathematical functions for the simplest of changes, multi-step algorithms for more complex changes, or abstract syntax trees for the most complex of changes.

Then in step 210, the update controller module 108 updates the declarative programming language. For example, the mapping function 110 may accept as its input a declarative document in one declarative programming language and format. The mapping function 110 may further generate as output another document in the required declarative programming language and format.

If it is determined that the data pod 128 is using an acceptable configuration in step 206, however, then the method may proceed directly to step 212. In step 212, the update controller module 108 executes a read of the compute pod 132. The compute pod 132 comprises containers that model or analyze the data structures in the associated data pod 128.

In step 214, the update controller module 108 sends a query to the compute pod 132 for the configuration that the compute pod 132 is using. For example, the update controller module 108 sends a query for the declarative programming language that the compute pod 132 is currently using.

In step 216, the update controller module 108 then determines if the compute pod 132 is using an acceptable configuration. For example, the system maintains a knowledge graph of impacted syntax, mapping functions 110, and ecosystem change types that informs the system what syntax to scan for and what mapping function 110 to apply to it for every ecosystem modification.

If it is determined that the compute pod 132 is not using an acceptable configuration, the method may proceed to step 218 in which the mapping function 110 is executed to update the compute pod 132 configuration. For example, the system maintains a knowledge graph of impacted syntax, mapping functions 110, and ecosystem change types that informs the system what syntax to scan for and what mapping function 110 to apply for every ecosystem modification. The mapping function 110 may be one-step mathematical functions for the simplest of changes, multi-step algorithms for more complex changes, or abstract syntax trees for the most complex of changes.

Then in step 220, the update controller module 108 updates the declarative programming language of the compute pod 132. For example, the mapping function 110 may accept as input a declarative document in one declarative programming language and format and generates as output another document in the required declarative programming language and format.

If it is determined that the compute pod 132 is using an acceptable configuration, then the method may proceed directly to step 222. In step 222, the update controller module 108 executes a read of the publication pod 136. The publication pod 136 comprises containers that publish or host analytical products developed in the compute pod 132 to a broader audience of users or machines (e.g., documents, websites, machine-to-machine services, and interfaces).

In step 224, the update controller module 108 sends a query to the publication pod 136 regarding the configuration that the publication pod 136 is using. For example, the update controller module 108 sends a query for the declarative programming language that the publication pod 136 is currently using.

In step 226, the update controller module 108 then determines if the publication pod 136 is using an acceptable configuration. For example, the system maintains a knowledge graph of impacted syntax, mapping functions 110, and ecosystem change types that informs the system what syntax to scan for and what mapping function 110 to apply to it for every ecosystem modification.

If it is determined that the publication pod 136 is not using an acceptable configuration, the method may proceed to step 228 in which the mapping function 110 is executed to update the publication pod 136 configuration. For example, the system maintains a knowledge graph of impacted syntax, mapping functions 110, and ecosystem change types that informs the system what syntax to scan for and what mapping function 110 to apply for every ecosystem modification. The mapping function 110 may be one-step mathematical functions for the simplest of changes, multi-step algorithms for more complex changes, or abstract syntax trees (i.e., tree representation of an abstract syntactic structure) for the most complex of changes.

Then in step 230, the update controller module 108 updates the declarative programming language of the publication pod 136. For example, the mapping function 110 may accept as input a declarative document in one declarative programming language and format and generates as output another document in the required declarative programming language and format. If the update controller module 108 determines that the publication pod 136 is using an acceptable configuration, then the process ends at step 232.

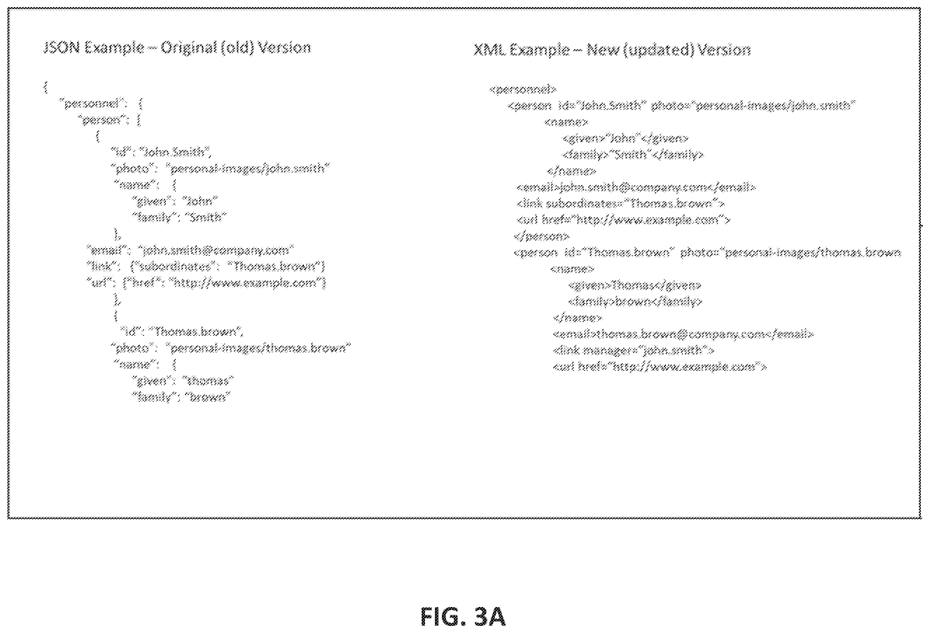

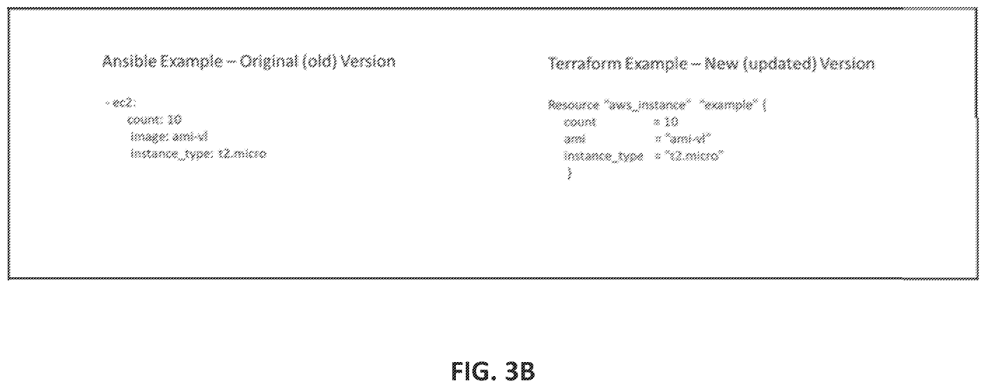

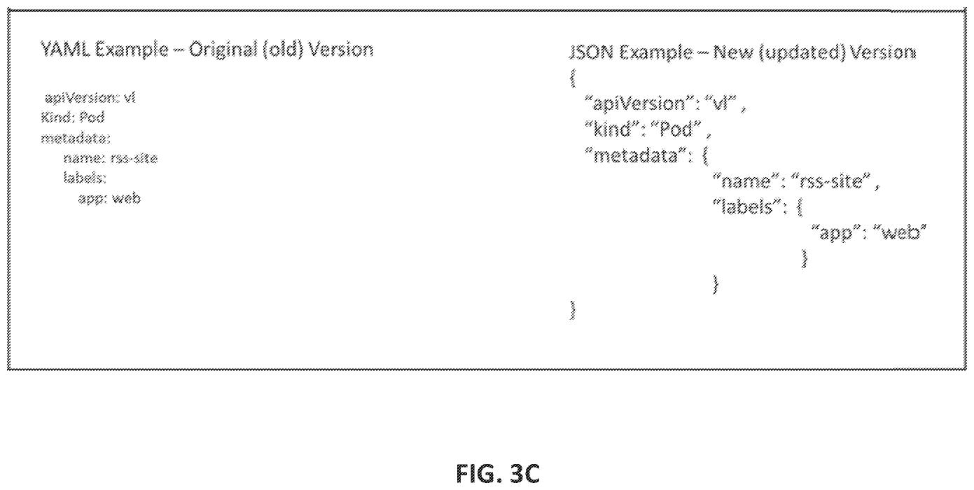

FIG. 3A-C illustrate exemplary mapping function transformations that may be executed upon data science containers. As illustrated the exemplary mapping function 110 transformations may be applied to a project (such as application, data structure, models, analysis tools, documents, websites, machine-to-machine services, and interfaces, etc.), which may be future-proofed by updating the declarative programming grammar in which deployment artifacts are written in to define and deploy pods (such as the data pod 128, compute pod 132, and publication pod 136 and their respective containers 130/134/138). Declarative programming language is a set of instructions that is order-dependent (e.g., YAML, XML, HTML, RDF, JSON). The mapping function 110 begins with querying the declarative programming language for the project, which allows the mapping function 110 to scan project deployment artifacts (such as the current declarative programming language being used) in the current environment and identify instructions that may fail in a changed future environment.

For example, the mapping function 110 can identify all deployment instructions that may fail because of an ecosystem change by querying the deployment instructions. The mapping function 110 can also transform declarative programming language. For example, a document written in a declarative programming language can be transformed into a different document written in the same declarative programming language, or even into a different document, or multiple documents, written in a different declarative programming language, or multiple declarative programming languages. A mapping function 110 may accept as input a declarative document in one declarative programming language and format. The mapping function 110 may further generate as output another document in the required declarative programming language and format. The ability to apply a mapping function 110 to a source deployment artifact and generate a target deployment artifact provides the ability to transform all project deployment artifacts from their pre-environmental-modification state to the required post-environment-modification state.

The system maintains a knowledge graph of impacted syntax, mapping functions 110, and ecosystem change types that specifies what syntax to scan for and what mapping function to apply for every ecosystem modification. The mapping functions may be one-step mathematical functions for the simplest of changes, multi-step algorithms for more complex changes, or abstract syntax trees (e.g., tree representation of an abstract syntactic structure) for the most complex of changes. In addition, every deployment artifact receives a Uniform Resource Identifier (URI) embedded as a comment, which enables the knowledge graph to build additional context about change impacts. The URIs represent the resources (metadata enrichment of certain entities) in the knowledge graph and enable efficient definition, application, testing, and reporting of mapping functions 110 on projects. In some embodiments, the system supports both manual and automatic generation of mapping functions 110, and also supports the creation of a market for third-party mapping functions 110. The system can accommodate Description Logic-based, Rule-based, and AST-based mapping functions 110 simultaneously.

FIG. 3A displays a first example of a transformation by the mapping function 110 as applied to the original declarative programming language, which used JSON. The original declarative programming language may be transformed to an updated and different declarative programming language (such as XML) in response to a change or update in the ecosystem. The mapping function 110 queries the project, which includes scanning the declarative programming language to determine whether the declarative programming language may fail. For example, the JSON declarative programming language used in the original may fail in an ecosystem that uses an XML declarative programming language. The mapping function 110 may accept as input the JSON declarative document in the JSON declarative programming language and format. The mapping function 110 may further generate as output another document in the XML declarative programming language and format, so that the project does not fail in the current ecosystem.

FIG. 3B displays a second example of the mapping function 110 in which the original declarative programming language used Ansible and transforms the original declarative programming to an updated declarative programming language due to a change or update in the ecosystem requiring a declarative programming language that uses Terraform. As discussed herein, the mapping function 110 queries the project by scanning and identifying if the Ansible declarative programming language in original script may fail in the changed ecosystem, which may require use of Terraform as the declarative programming language. Thus, the mapping function 110 may accept as input the Ansible declarative document in the Ansible declarative programming language and format, while generating as output another document in the Terraform declarative programming language and format identified as being required so as not to fail in the current ecosystem.

FIG. 3C displays a first example of the mapping function 110 in which the original declarative programming language used YAML and transforms the original declarative programming to an updated declarative programming language due to a change or update in the ecosystem to a declarative programming language that uses JSON. The mapping function 110 queries the project and scans and determines whether the YAML declarative programming language used in the original may fail in an ecosystem that currently uses a JSON declarative programming language. The mapping function 110 may accept, as its input, the YAML declarative document in the YAML declarative programming language and format, and generate, as its output, another document in the JSON declarative programming language and format so that the project does not fail in the current ecosystem.

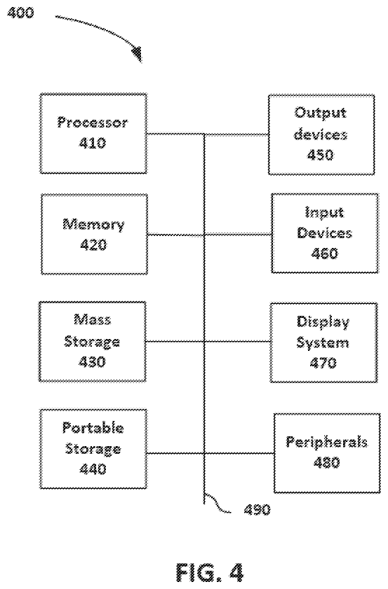

FIG. 4 illustrates an exemplary computing system 400 that may be used to implement an embodiment of the present invention. The computing system 400 of FIG. 4 includes one or more processors 410 and memory 420. Main memory 420 stores, in part, instructions and data for execution by processor 410. Main memory 420 can store the executable code when in operation. The system 400 of FIG. 4 further includes a mass storage device 430, portable storage medium drive(s) 440, output devices 450, user input devices 460, a graphics display 470, and peripheral devices 480.

The components shown in FIG. 4 are depicted as being connected via a single bus 490. However, the components may be connected through one or more data transport means. For example, processor unit 410 and main memory 420 may be connected via a local microprocessor bus, and the mass storage device 430, peripheral device(s) 480, portable storage device 440, and display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing embodiments of the present invention for purposes of loading that software into main memory 420.

Portable storage device 440 operates in conjunction with a portable non-volatile storage medium, such as a floppy disk, compact disk or digital video disc, to input and output data and code to and from the computer system 400 of FIG. 4. The system software for implementing embodiments of the present invention may be stored on such a portable medium and input to the computer system 400 via the portable storage device 440.

Input devices 460 provide a portion of a user interface. Input devices 460 may include an alpha-numeric keypad, such as a keyboard, for inputting alpha-numeric and other information, or a pointing device, such as a mouse, a trackball, stylus, or cursor direction keys. Additionally, the system 400 as shown in FIG. 4 includes output devices 450. Examples of suitable output devices include speakers, printers, network interfaces, and monitors.

Display system 470 may include a liquid crystal display (LCD) or other suitable display device. Display system 470 receives textual and graphical information, and processes the information for output to the display device.

Peripherals 480 may include any type of computer support device to add additional functionality to the computer system. For example, peripheral device(s) 480 may include a modem or a router.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, hand-held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems. The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for transformation of data science containers, the method comprising:
storing information in memory regarding a project associated with a plurality of different pods, wherein the stored information includes a map of a plurality of relationships among containers of project components associated with each of the pods;
receiving information regarding a requested ecosystem configuration;
querying at least one of the pods regarding a current configuration status;
identifying that the current configuration status of the at least one pod is not acceptable in accordance with the requested ecosystem configuration; and
executing a mapping function to update the respective configuration status of the at least one pod based on the mapped relationships stored in memory, wherein execution of the mapping function generates instructions for one or more configuration changes that implement the update to the requested ecosystem configuration.

2. The method of claim 1, wherein the received information pertains to an ecosystem or environment modification, and further comprising identifying the requested ecosystem configuration based on the ecosystem or environment modification.

3. The method of claim 1, wherein the stored map for the at least one pod includes a knowledge graph representing syntax associated with behaviors of the project components, wherein the knowledge graph further identifies one or more types of ecosystem change types that impact the syntax and one or more configuration changes to apply based on each ecosystem change type.

4. The method of claim 3, further comprising building a learning model for the project based on the knowledge graph, and making a prediction that the current configuration status of the at least one pod will fail in response to a new ecosystem or environment parameter, wherein identifying that the current configuration status of the at least one pod is not acceptable is based on the prediction.

5. The method of claim 3, further comprising identifying that the requested ecosystem configuration corresponds to one of the ecosystem change types, wherein identifying that the respective configuration status of the at least one pod is not acceptable is based on the identified ecosystem change type.

6. The method of claim 3, further comprising scanning current syntax of the project components of the at least one pod based on the knowledge graph to identify a set of syntax impacted by the requested ecosystem configuration, and identifying the configuration changes based on the identified set of impacted syntax.

7. The method of claim 6, wherein the set of impacted syntax includes at least one of declarative programming language type, declarative grammars, and declarative documents.

8. The method of claim 6, further comprising executing the identified instructions, wherein the identified instructions are executed to update declarative programming language and format corresponding to the identified set of impacted syntax in accordance with the configuration changes, wherein updating the update declarative programming language and format includes generating a different declarative programming language and format that corresponds to the requested ecosystem configuration.

9. The method of claim 8, wherein the declarative programming language and format corresponding to the identified set of impacted syntax correspond to a current document, and wherein generating the different declarative programming language and format includes generating one or more different documents.

10. The method of claim 8, wherein the at least one pod is queried regarding the declarative programming language corresponding to the identified set of impacted syntax.

11. The method of claim 1, further comprising identifying the mapping function from among a plurality of different available mapping functions based on a type of the configuration changes, and generating the instructions based on the identified mapping function.

12. The method of claim 1, wherein querying the at least one pod includes querying one or more container management artifacts of the at least one pod based on the requested ecosystem configuration, and wherein querying the deployment artifacts results in identifying the configuration changes that implement the update to the requested ecosystem configuration.

13. The method of claim 11, further comprising assigning each artifact a uniform resource identifier (URI), and embedding the URI in a knowledge graph that includes the artifacts.

14. The method of claim 1, further comprising automatically generating the mapping function to update the respective configuration status of the at least one pod.

15. The method of claim 1, wherein the plurality of different pods includes at least one of a data pod, a compute pod, and a publication pod.

16. The method of claim 1, wherein the different pods of the project are stored in a cloud ecosystem.

17. A system for transformation of data science containers, the system comprising:
memory that stores information in memory regarding a project associated with a plurality of different pods, wherein the stored information includes a map of a plurality of relationships among containers of project components associated with each of the pods;
a communication interface that communicates over a communication network, wherein the communication interface receives information regarding a requested ecosystem configuration; and
a processor that executes instructions stored in memory, wherein the processor executes the instructions to:
query at least one of the pods regarding a current configuration status;
identify that the current configuration status of the at least one pod is not acceptable in accordance with the requested ecosystem configuration; and
execute a mapping function to update the respective configuration status of the at least one pod based on the mapped relationships stored in memory, wherein execution of the mapping function generates instructions for one or more configuration changes that implement the update to the requested ecosystem configuration.

18. A non-transitory, computer-readable storage medium, having embodied thereon a program executable by a processor to perform a method for transformation of data science containers, the method comprising:
storing information in memory regarding a project associated with a plurality of different pods, wherein the stored information includes a map of a plurality of relationships among containers of project components associated with each of the pods;
receiving information regarding a requested ecosystem configuration;
querying at least one of the pods regarding a current configuration status;
identifying that the current configuration status of the at least one pod is not acceptable in accordance with the requested ecosystem configuration; and
executing a mapping function to update the respective configuration status of the at least one pod based on the mapped relationships stored in memory, wherein execution of the mapping function generates instructions for one or more configuration changes that implement the update to the requested ecosystem configuration.
